(19) United States
(12) Patent Application Publication
(10) Pub. No.: US 2012/0131361 A1
(43) Pub. Date: May 24, 2012

(54) REMOTE CONTROLLER AND METHOD FOR REMOTELY CONTROLLING MOTHERBOARD USING THE REMOTE CONTROLLER

(75) Inventor: JO-YU CHANG, Tu-Cheng (TW)

(73) Assignee: HON HAI PRECISION INDUSTRY CO., LTD., Tu-Cheng (TW)

(21) Appl. No.: 13/301,702

(22) Filed: Nov. 21, 2011

(30) Foreign Application Priority Data
Nov. 23, 2010 (TW) 099140462

(51) Int. Cl. G06F 1/26

(52) U.S. Cl. 713/310

(57) ABSTRACT

A remote controller is connected to one or more server via an intelligent platform management bus (IPMB). The controller includes a redundant power supply and a remote control module. Once the remote controller receives a control command to power on one of the servers from a system administer, the remote control module powers on the server, and sends an operation command to control a motherboard of the server to run. By utilizing the remote controller, the system administrator can remotely control baseboard management controllers of the servers when the power supply of the server does not have an AC power.

### BACKGROUND

1. Technical Field

Embodiments of the present disclosure generally relate to motherboard control devices and methods, and more particularly to a remote controller and a method for remotely controlling a motherboard.

2. Description of Related Art

Intelligent platform management interface (IPMI) is a standardized computer system interface used by system administrators to manage a computer system and monitor its operation. An IPMI sub-system consists of a main controller, called the baseboard management controller (BMC) and other management controllers distributed among different system modules that are referred to as satellite controllers. A system administrator can use a remote management card (RMC) to control the BMC of a server via an intelligent platform management bus (IPMB). However, if the server does not support a DC power or if the server does not have a AC power, the RMC cannot manage the server. Therefore, a method for remotely controlling a motherboard is desired.

### BRIEF DESCRIPTION OF THE DRAWINGS

FIG. 1 is a block diagram of one embodiment of a remote controller communicating with one or more servers.

FIG. 2 is a block diagram of one embodiment of a signal flowchart remotely controlling a motherboard.

FIG. 3 is a block diagram of one embodiment of the remote controller.

FIG. 4 is a flowchart illustrating one embodiment of a method for remotely controlling a motherboard.

### DETAILED DESCRIPTION

In general, the term “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or other computer storage device.

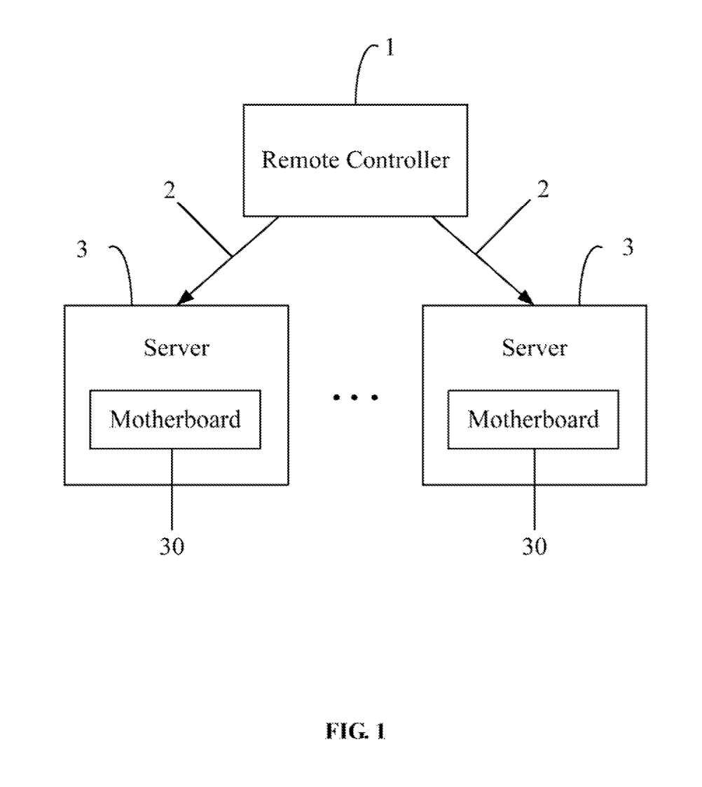

FIG. 1 is a block diagram of one embodiment of a remote controller 1. In the embodiment, the remote controller 1 runs in an integrated system. The integrated system includes one or more servers 3 (only two servers shown in FIG. 1). The remote controller 1 communicates with each of the servers 3 via an intelligent platform management bus (IPMB) 2. Each of the servers 3 comprises a motherboard 30, and is controlled by the remote controller 1.

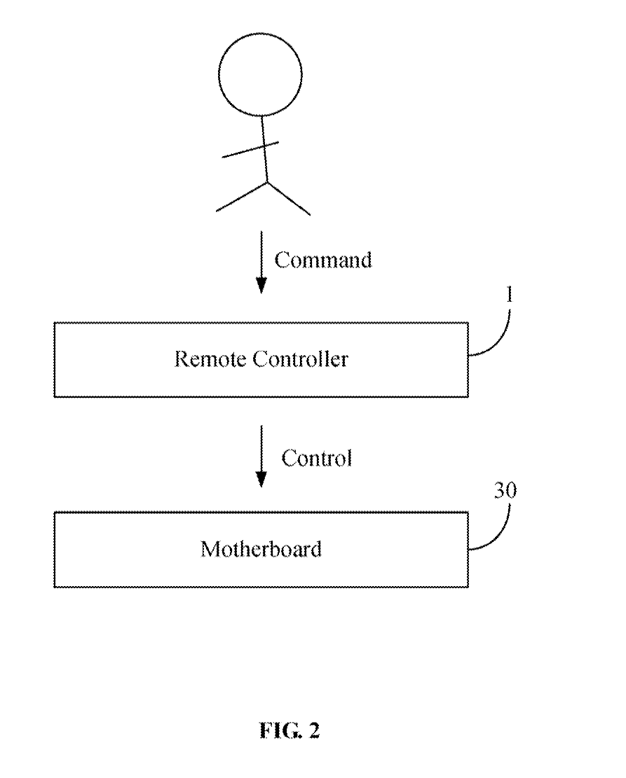

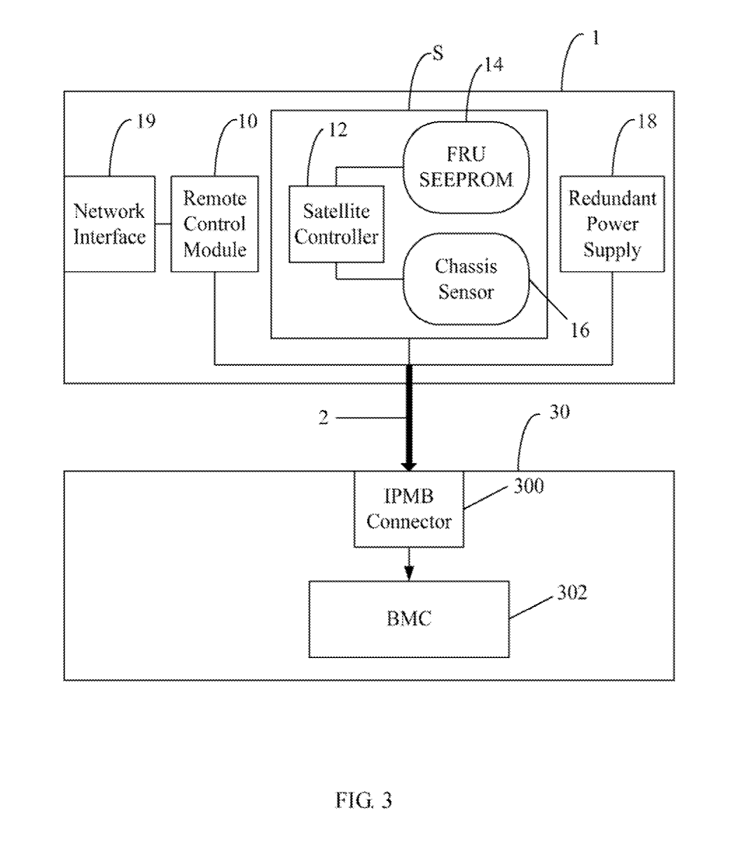

As shown in FIG. 2, once the remote controller 1 receives commands from a system administrator via a network (e.g., Internet, intranet), the remote controller 1 remotely controls the motherboard 30 of each of the servers 3 via the commands. For example, the remote controller 1 controls each of the servers 3 to power on, and controls a baseboard management controller (BMC) 302 (as shown in FIG. 3) of the motherboard 30 to perform one or more functions. In one embodiment, the BMC 302 may provide a hot plug function, a monitoring function, an alarm function, a log record function, and a remote maintenance function of the server 3.

FIG. 3 is a block diagram of one embodiment of the remote controller 1. In the embodiment, the remote controller 1 is equipped with a series of components, such as a satellite controller 12, a field replaceable unit serial EEPROM (FRU SEEPROM) 14, a chassis sensor 16, a redundant power supply 18, and a network interface 19. The series of components ensure that the remote controller 1 can receive a control command to power on the server 3, and control the server 3 to perform operations required by the system administrator.

Furthermore, the remote controller 1 includes a remote control module 10 that receives commands from the system administrator via the network interface 19, such as the control command to power on one of the servers 3. The remote control module 10 controls the corresponding server 3 to power on using the redundant power supply 18. In the embodiment, the redundant power supply 18 provides a direct-current to power on the server 3.

When the system administrator sends an operation command to the remote controller 1, the remote control module 10 transmits the operation command to the motherboard 30 of the server 3 via the IPMB 2. The BMC 302 receives the operation command via the IPMB connector 300. The remote control module 10 controls the BMC 302 to perform the operation command.

Because the remote controller 1 is compatible with a standard of the IPMB connector 300, the remote controller 1 can control motherboards manufactured by different factories.

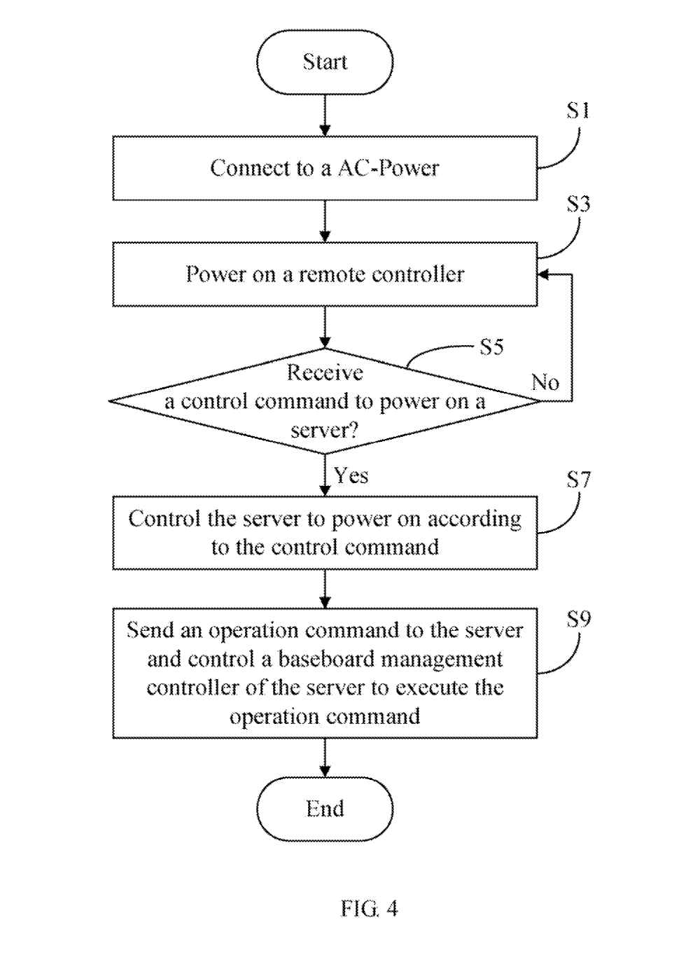

FIG. 4 is a flowchart illustrating one embodiment of a method for remotely controlling a motherboard by using the remote controller 1 of FIG. 3. Depending on the embodiment, in FIG. 4, additional blocks may be added, others removed, and the ordering of the blocks may be changed.

In block S1, the system administrator connects the remote controller 1 to an AC power of a power supply, and connects one or more servers 3 to the remote controller 1 via an intelligent platform management bus 2. Each of the servers 3 comprises the motherboard 30.

In block S3, the remote controller 1 is powered on by the system administrator.

In block S5, the remote control module 10 determines whether the remote controller 1 has received a control command to power on one of the servers 3. Upon the condition that the remote controller 1 has received the control command, the flow goes to block S7. Upon the condition that the remote controller 1 has not received the control command, the flow returns to block S3.

In block S7, the remote control module 10 uses the redundant power supply 18 to power on the server 3 according to the control command

In block S9, when an operation command is sent to the remote controller 1, the remote control module 10 transmits the operation command to the server 3 via the IPMB 2, and controls the BMC 302 of the server 3 to perform the operation command.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for remotely controlling one or more servers, the method comprising:
powering on a remote controller that is connected to the one or more servers via an intelligent platform management bus;
determining whether the remote controller has received a control command to power on one of the servers;
upon the condition that the remote controller receives the control command, controlling the corresponding server to power on using a redundant power supply of the remote controller;
sending an operation command to one of the servers via the intelligent platform management bus; and
controlling a baseboard management controller of the server to execute the operation command.

2. The method as described in claim 1, wherein the redundant power supply provides a direct-current to power on the server.

3. The method as described in claim 1, wherein the remote controller is equipped with a satellite controller, a field replace unit serial EEPROM, a chassis sensor, and a network interface.

4. The method as described in claim 1, wherein the remote controller is connected to an intelligent platform management connector of the server.

5. The method as described in claim 4, wherein the remote controller is compatible with a standard of the intelligent platform management connector.

6. A remote controller connected to one or more servers via an intelligent platform management bus comprising:
a redundant power supply; and
a remote control module operable to receive a control command to power on one of the servers form a system administrator, control the server to power on using the redundant power supply, send an operation command to the server via the intelligent platform management bus, and control a baseboard management controller of the server to execute the operation command.

7. The remote controller as described in claim 6, wherein the redundant power supply provides a direct-current to power on the server.

8. The remote controller as described in claim 6, wherein the remote controller is further equipped with a satellite controller, a field replace unit serial EEPROM, a chassis sensor, and a network interface.

9. The remote controller as described in claim 6, wherein the remote controller is connected to an intelligent platform management connector of the server.

10. The remote controller as described in claim 9, wherein the remote controller is compatible with a standard of the intelligent platform management connector.
